(19) United States
(12) Patent Application Publication
(10) Pub. No.: US 2005/0065830 A1
(43) Pub. Date: Mar. 24, 2005

(54) System and method for the acquisition and analysis of data for print shop performance evaluation and adjustment

(75) Inventors: Charles B. Duke, Webster, NY (US); Sudhendu Rai, Fairport, NY (US)

Correspondence Address: Patrick R. Roche, Esq.;FAY, SHARPE, FAGAN, MINNICH & McKEE, LLP, SEVENTH FLOOR, 1100 SUPERIOR AVENUE, CLEVELAND, OH, 44114-2579, US

(73) Assignee: Xerox Corporation

(21) Appl. No.: 10/946,756

(22) Filed: Sep. 22, 2004

Related U.S. Application Data
(60) Provisional application No. 60/505,676, filed on Sep. 24, 2003.

(51) Int. Cl. G06F 17/60

(52) U.S. Cl. 705/7; 705/8

(57) ABSTRACT

Data representative of print shop performance is acquired and analyzed for maximizing the job flow rate through the print shop. The data acquisition comprises characterizing the shop, characterizing the job flow through the shop, analyzing a current state, and assessing possible future states for maximizing the job flow. The data acquisition, analysis and adjustment of shop operations is effected in real time.

This application claims the priority of U.S. Provisional Application Ser. No. 60/505,676, filed Sep. 24, 2003.

### RELATED APPLICATIONS

Production Server for Automated Control of Production Document Management (Squires, et al., D/A0417, pending application Ser. No. 09/706,078, filed Nov. 3, 2000);

Print Shop Resource Optimization Via the Use of Autonomous Cells (Duke, et al., D/A0130, pending application Ser. No. 09/706,430, filed Nov. 3, 2000); and

Methods and Systems for Determining Resource Capabilities for a Lean Production Environment, (Gartstein, et al. pending application Ser. No. 10/756,210, filed Jan. 12, 2004), the disclosures of which are totally incorporated herein by reference.

### BACKGROUND

The present embodiments relate to systems and methods for the acquisition and analysis of data for print shop performance evaluation and the use of feedback based on flow metrics to control print shop productivity. By “flow metrics” is meant the quantity of printed materials (e.g., number of pages, sets of books) that moves from one production stage to another per unit time. It finds particular application in conjunction with print shop workflows and performance evaluation, and will be described with particular reference thereto. However, it is to be appreciated that the present exemplary embodiments are also amenable to other like applications.

The costs for operating a print shop are generally categorized as the capitalization cost of the printing equipment, and the operating and employment costs for running the equipment. As print shops tend to transform from being lithographic to digital, additional equipment costs will be incurred, so that how the facilities of the print shops are managed becomes even more important to achieve the desired and more profitable operating results.

Print shops face regular pressures to reduce the costs and improve the productivity of their printing processes. This pressure exists whether a print shop is classified as a job print shop, e.g., one producing small-run individual print jobs for customers, a transactional print shop, e.g., one producing statements for a brokerage firm, or a production print shop, e.g., one producing large-run catalogs for mail order businesses. No matter which class a print shop falls into, each print shop operates in essentially the same way. It accepts a digital file, flat sheet stack, bound material or other original as a job input, operates upon this job according to customer instructions, e.g., paper selection, binding, and distribution, and produces a final product which is then transferred and billed to the customer.

The traditional print shop operation is separated into departments, such as data processing and e-prep, printing, finishing, and shipping departments. Each job progresses sequentially through the various departments. Operators are usually trained to operate one piece of equipment. Like pieces of equipment are usually grouped together within each department, and one operator per machine is required for each shift. This configuration produces frequent waste and requires large amounts of inter-shop inventory, which must then be moved from department to department as a job progresses through the print shop. This traditional method of print shop operation causes frequent delays in meeting job delivery dates, increases waste, and takes up a maximum amount of floor space. As a print shop ramps up its production, accurate job production time becomes increasingly difficult to estimate, often resulting in frequent overflow which must be outsourced to other print shops.

The scheduling and flow of jobs through print shops today is typically controlled by preset, often manual, scheduling policies and workflows that take into consideration only the overall equipment, physical layout and labor in the shop. Workflow is typically fixed in a departmental framework. Emphasis is given to keeping all the equipment busy, with the consequence that a lot of work in progress is generated, jobs are often late, error rates are large, and the exact status of specific jobs in progress in the shop is generally not known. Therefore, the productivity of the vast majority of print shops is far from the optimal that can be realized using modern control theory methods to adjust the scheduling, labor, and workflow to respond to both changes in the incoming job flow and to the state of the shop when the jobs are arriving.

Methods exist for improving the operation of the traditional print shop. One method involves re-conceptualizing a traditional print shop as a type of factory process. The print shop itself is then synonymous with the factory plant, and the print job with the manufactured product. Once thus re-conceptualized, commonly known factory flow processes, such as those discussed by Wallace J. Hopp and Mark L. Spearman in Factory Physics (McGraw Hill: New York, 1996) may be adapted to the print shop environment and used to improve the flow of print jobs through the print shop.

In accordance with another method, a print shop may be reorganized into autonomous cells as disclosed in co-pending application Ser. No. ______ Sudhendu Rai, et al. Autonomous cells group equipment together according to different job classes commonly encountered by a specific print shop. The jobs are then broken down into smaller sub-jobs and processed through the cells. Another method to improve operation is to cross-train operators on multiple pieces of equipment. Operators can then be allocated more flexibly as needed throughout the shop. Opportunities also exist to improve scheduling of jobs so as to reduce the amount of inventory and to more fully utilize equipment. An additional option is to improve the layout of equipment on the print shop floor in order to decrease the amount of excess movement required within the print shop. When implemented, these methods have been shown to reduce costs of all classes of print shops by up to twenty percent within six months of implementing the methods.

Although these methods for operational improvement exist, print shop owners are understandably slow to change their traditional methods of operations. One reason for hesitation is that change is typically quite invasive, requiring re-training operators, moving heavy equipment, and learning new habits, all of which equates to down time and lost productivity for the shop during transition. This lost productivity is problematic for a shop owner who must keep the shop operating smoothly throughout transition periods. There is thus little incentive for a print shop owner to make operational changes without having quantitative data showing a positive benefit to boftom-line profits. It is therefore problematic that print shop owners typically have insufficient data to quantify the extent of possible gains available to them by implementing improved operational methods.

Many print shops do acquire some data on such figures as equipment utilization, labor utilization, and percent of jobs completed on-time that are used as average characterizations of shop performance. Almost all print shops collect data for billing and evaluation of on-time delivery of jobs. However, the global nature of this data limits its ability to assist the print shop owner in making value added changes to the workflow through the print shop. The print shop owner typically uses this limited data in an ad hoc manner to make empirical adjustments in global shop policies based on heuristics that make sense to the local print shop owner. As a result, print shop owners rarely know just how poorly their shops are performing. There is no systematic and detailed way to quantify the amount of savings and productivity improvement that may be achieved using the above-mentioned methods for improving print shop operations.

Moreover, even if print shop owners had the data necessary to recognize that their shops are operating poorly, print shop owners have no way to implement changes to their operations and then continue to adapt to ongoing operational variables, such as equipment failure, irregular arrival of jobs, and fluctuations in the availability of labor, etc.

Thus, what is needed is a system and method for characterizing a print shop and defining a comprehensive set of flow metrics, and for measuring, analyzing, and modeling those flow metrics for the print shop owner in order to quantify for a print shop owner the amount of savings and productivity improvement that may be achieved by using an improved method of operation. Moreover, once the measurement of flow metrics has been implemented, what is needed is a system and method for print shop owners to use feedback from flow-metrics to continually monitor and adapt their operations to changing operational variables.

### BRIEF DESCRIPTION

In accordance with one aspect of the present embodiments, a system and method for collecting and analyzing data on print shop performance that allows a quantitative assessment of that performance and the identification of opportunities for improvement is disclosed. Data are collected on the flow of job events through the shop: their characteristics, the process steps required for their completion, their duration at each step of the work process, and ancillary information of the casuals of their characteristics at each work process step (e.g., the required machine is broken, the required labor is unavailable, the cause of machine failure when it has occurred). They are collected via multiple means: manually, via hand-held scanners, via keystroke entry, via rf tags, etc.) The data are analyzed using methods and simulations that model the workflow through the shop in terms of work process steps that are described in statistical terms (e.g., distributions of jobs in buffers, execution time distributions of various work process steps, statistical distributions of failure and repair time of individual machines). The outputs of these analyses are quantitative current state operational metrics of print shop operations such as equipment utilization, labor utilization, floor space utilization, shop capacity, job and volume profiles, labor costs, set-up costs, work in progress waste and timeliness.

In accordance with another aspect of the subject embodiments, a method and system is disclosed for characterizing the flow of jobs through a print shop and using this characterization to provide real time feedback resulting in changes in the scheduling of these jobs, their routing through the shop, and the allocation of labor resources in the shop. The internal state of the shop and all the jobs therein is characterized by metrics based on the flow of jobs through the shop (e.g., utilization of specific pieces of equipment and labor skills, turn-around time, waiting time at specific work stations, work in progress at specific points in the flow, the time it takes to do specific operations, or the start, interrupt or stop status of specific jobs). Using these metrics to characterize the state of the shop at specific points in time, feedback control policies are applied to reschedule or reroute jobs, or to reallocate labor resources in real time so as to improve the measured metrics. This generation of sensory feedback based on flow metrics, combined with the actuation mechanisms of job rerouting, job rescheduling, and labor reallocation, results in vast improvements in the productivity of most print shops.

### BRIEF DESCRIPTION OF THE DRAWINGS

FIG. 1 is diagram depicting how a print shop may be partitioned into autonomously operating cells;

FIG. 2 is a graph describing a document production job;

FIG. 3 is a block diagram illustrating exemplary data acquisition;

FIG. 4 is a flow chart showing data analysis methods; and

FIG. 5 is a flow chart showing adjusting of job scheduling based on real time feedback of flow metrics.

### DETAILED DESCRIPTION

Print shops are typically organized into departmental units (all printers together, all binders together, etc.) and print jobs are processed through the departments in sequential steps. Simple algorithms are used to schedule the jobs moving through the shop, e.g., first in first out, smaller jobs first, higher priority jobs first, etc. The flow of jobs can be improved by organizing the print shop into autonomous cells and breaking up large jobs into smaller batches.

Print shops collect widely varying amounts and types of data on their equipment, jobs and labor assignments. Essentially all shops collect data for billing and the evaluation of their on-time delivery of jobs. These data may or may not contain a specification of all the processes needed to complete the job and information on how the job traverses the shop, e.g., when it enters and exits each of these processes and the operator(s) who perform the process. Few shops measure the productivity of each of their pieces of equipment and the variations in this productivity due to the use of different operators and to machine failures and their repair. Acquisition of job characteristic and status data is generally an expensive manual process. The subject embodiments comprise the acquisition of comprehensive data on the equipment, job mix, job flow and labor assignments of a print shop, typically by semi automated means like the use of hand helds to read bar codes printed on jobs in the shop and automatically record the jobs progress through the shop. Given these data items, improved analyses of the data using process models of the shop that are amenable to analysis relative to alternative configurations and control policies in order to assess the productivity of the shop relative to these alternatives is facilitated. Additionally, by measuring the flow of jobs at various points I the work process, and using flow metrics to characterize this flow, the state of flow in the shop at selected instants in time can be evaluated and this information used to change the scheduling of the jobs, their routing and the allocation of labor in such a fashion as to improve the flow and hence the productivity of the shop.

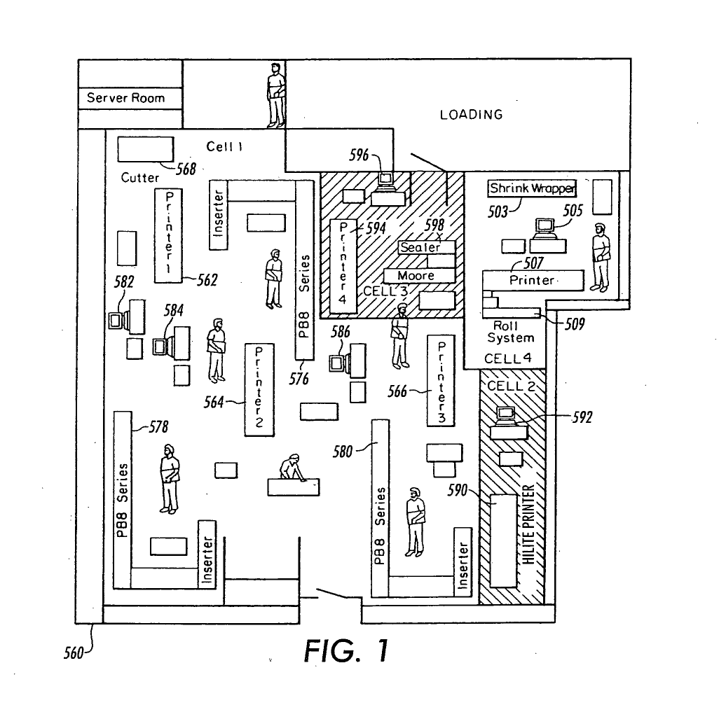

FIG. 1 shows a sample of a print shop laid out into four autonomous cells. Cell 1 includes printers 562, 564, 566 and inserters 576, 578, 580. A cutter 568 is also included in cell 1 as are computing resources 582, 584. The resources may include server computers that execute software for automatically assigning print jobs to given cells and for processing print jobs once they arrived in the given cells. Moreover, the computing resources may provide the print shop operators to control the operation of the equipment within the cell. Cell 2 includes computer system 592 and a highlight printer 590. Cell 3 includes a printer 594 as well as a sealer 598 and the computer system 596. Lastly, cell 4 includes a shrink wrapper 503, computer system 505, a printer 507 and a roll system 509. The relevant data defining the processing of a job through a print shop is acquired in a manner in accordance with the present embodiments to facilitate print shop rearrangement or job processing adjustments between the cells and the elements in the cell.

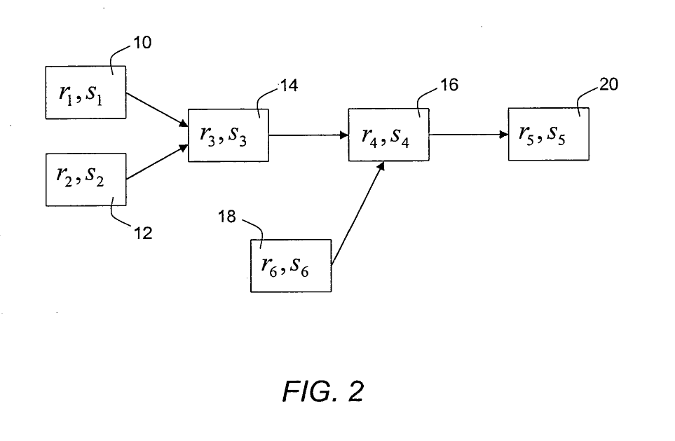

With reference to FIG. 2, the model used to analyze the data comprises a job as it flows through the shop in a sequential series of production steps, labeled by the index i, characterized by a processing time of rᵢ time units per production item and a set-up time of sᵢ time units to change from one type of job to another. Then a job comprises of a trajectory through the shop described by a linked graph of production steps as shown in FIG. 2. The boxes 10, 12, 14, 16, 18, 20 describe the production steps required to create the job. The arrows indicate sequential next steps. Jobs flow along the arrows, so that with each arrow there is an associated flow rate of quantity per unit time as the job would progress through a shop such as that shown in FIG. 1. The parameters r and s describe the processing rate and set up time of the various possible operations. If more than one production step is associated with the same machine, then the sᵢ associated with that machine are not independent. In addition, probabilities of failure and repair are associated with each process step (not shown in the box).

Variability enters the shop by virtue of the fact that most of the production steps involve machines (printers, binders, staplers, etc.) that fail, assumed randomly, with mean probability of failure of p_{f} and a mean probability of repair (after failure) of Pᵣ. Typically one assumes that both probability distributions are exponentially characterized by mean times to fail and repair. Variability also enters the shop via the irregular arrival of jobs and fluctuations in the availability of labor to perform the various production processes. Thus, if buffers (not shown) are introduced between production steps (i.e., work in process “WIP”), we find that the occupancy of the various buffers can fluctuate widely. Buffers in which WIP piles up identify bottlenecks and empty buffers identify production steps that are not utilized to their capacity. At any moment in time the shop is characterized by the jobs in progress, the occupancies of all the buffers, the running-idle—broken state of each process, and the assignment of labor to the various processes.

A print shop is characterized by the process steps that it supports, described diagrammatically by the boxes in FIG. 2 and characterized by their production times, set up times, times to failure, times to repair, and required labor assignments. For a given print shop this information is acquired by interviewing the print shop operator using a formalized, stylized query sheet designed to identify the production processes and estimates of their parameters. Once the shop has been characterized, a similar inquiry is launched to describe the jobs run by that shop. Each job is described by a graph like that in FIG. 2. The shop can then be described by the collection of equivalence classes of topologically equivalent directed acyclic graphs that describe the jobs run by the shop. Its state at any time is described by the collection of graphs describing all the jobs in progress, the state of each process, and the occupancies of all the buffers.

The subject development concerns the acquisition of the data that are required to specify selected local states of the print shop and the use of these data to characterize the specified state(s) of the shop, evaluate its productivity based on these states, and compare this performance with alternatives. Typically the print shop will be modeled with discrete-event simulations based on equipment parameters determined by the interview process and a hypothetical job mix based on extrapolations from data acquired from the actual jobs over a sampling time period. The time dependence of the job mix is considered explicitly in the modeling. Bottlenecks are identified and procedures for mitigating them are identified and modeled to determine their effectiveness. These mitigations are presented to the print shop operator in the form of a list of potential improvements ordered in some fashion (e.g., benefit of implementation, cost of implementation, speed/ease of implementation etc). Operator feedback on the feasibility and cost of the mitigations may be incorporated into a second round of proposals. Based on these analyses and data about the cost of labor, renovations and equipment, the financial consequences of a proposed set of modifications can be estimated. If the operator elects to adopt one or more of these proposals, the model based on the data is used as the basis for planning the reorganization of the workflow, the revised layout of the shop, the cross training of operators, the scheduling of jobs in the shop. Thus, the acquisition and analysis of these data form the basis for a set of services offered to the print shop manager to analyze the shop, its capabilities, its costs, and to suggest specific changes in work process, layout, equipment, staffing and staff training, scheduling, and the control process determining scheduling and routing in the shop, that will improve the performance of the shop by amounts that can be estimated to within roughly 10%. The essence of this subject embodiment is a practical methodology for acquiring the requisite data, analyzing it, and suggesting practical improvements that when implemented resulted in on-average a 20% cost saving that fell to the bottom line as profit.

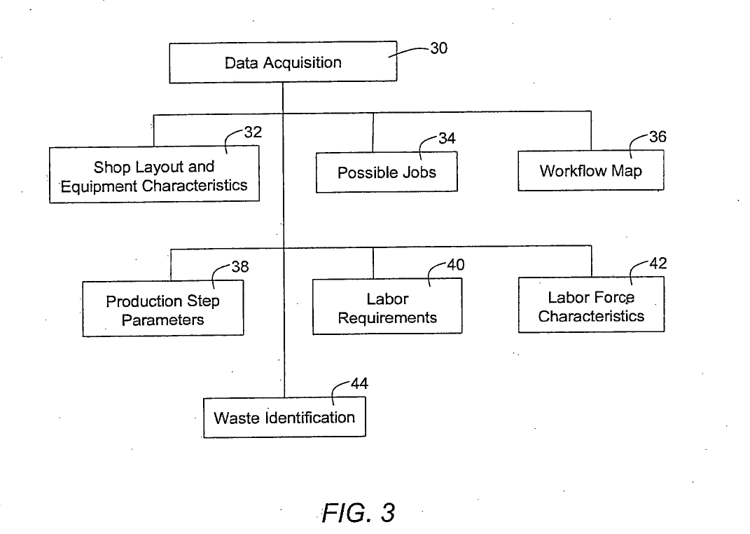

The required data to be acquired 30 fall into seven classes, FIG. 3. First, the layout 32 of the shop floor and the characteristics of its equipment must be determined. This includes the cost of square footage and of the (depreciating) equipment. The layout of the shop is described by a plan diagram, typically rendered to scale (e.g., FIG. 1). Second, data on the possible jobs 34 are acquired. These include information like arrival times, due dates, actual ship dates, cost and price, and often information on how the job moves through the shop floor (e.g., arrival and completion times for each production step, the name of the operator generating each step etc.). The jobs are broken up into equivalence classes as described in connection with FIG. 2. Third the flow of work 36 for each equivalence class is mapped onto the layout diagram. Fourth, the parameters 38 associated with each production step are determined. Fifth, the labor requirements 40 for each production process are specified. Sixth, the characteristics of the labor force 42 are determined, especially the availability of certain skills during specified time periods. Seventh, information on waste 44 is acquired. Work in progress (WIP) at each production step is measured. Information on damage rates and rework is acquired, preferably for each production step.

These data are acquired by a wide variety of means. Shop layout data can be acquired from prior drawings or specified by shop floor measurements in real time (e.g., by tape measurements or ultrasonic or laser range finders). Cost data are obtained from shop financial records. Job data can be obtained either manually or semi-automatically. At the manual extreme the parameters of the job can be written down on job tickets that are physically associated with each job. Alternatively this information can be keyed into a computer and printed out on bar coded job tickets that are physically associated with each job. Then these can be swiped with hand helds (and extra data keyed in with each swipe) to give a complete record of how the job progressed through the shop. Another alternative to keystroke job ticket entry is to construct rf tags that accompany the job (e.g., are taped to the physical job ticket) and can be read at the beginning and end of each production step. The mapping of the flow of work to the layout diagram is done manually at the present time, but could be automated if that proved cost effective. The parameters associated with the production steps are typically measured (e.g., using stop watches) or extracted from the records of the shop (e.g., machine counters for processing times, historical failure and repair times). Labor requirements are obtained by observation of the current operation of the shop. Characteristics of the labor force are obtained from shop records. Waste is measured by direct observation of current operations or (less often) by comparing shipping information with meter reads.

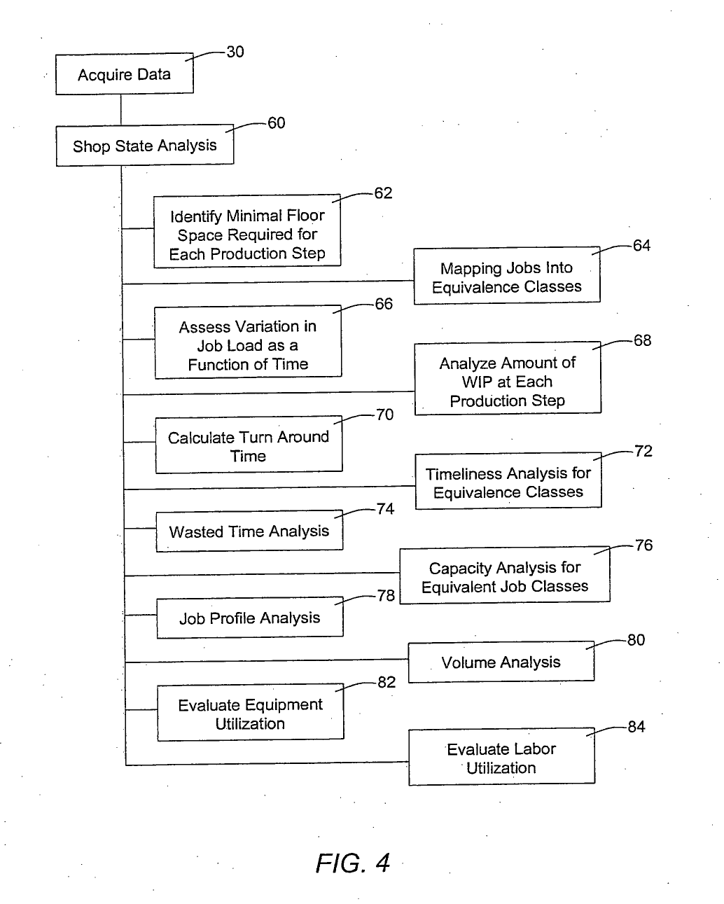

With reference to FIG. 4, the current state of the shop is analyzed 60 in the following ways. Usage of the floor space is analyzed by identifying the minimal space required for each production step and comparing the sum of these requirements with the actual floor space. Typically the minimal space is much smaller than the actual space, indicating that a lot of WIP is on the floor or that the physical flow of work through the shop is not organized efficiently. Job data are analyzed for a variety of things. The mapping 64 of jobs into equivalence classes already has been discussed above. The variations in job load as a function of time (daily, weekly, monthly) are assessed 66. The amount of WIP on the floor (e.g., at each production step) is analyzed 68 to determine how it fluctuates with time both for each job class and in total. The combination of the WIP and arrival rate for each job class determines 70 the average turn-around time for that class by Liftle's law, L=λW, where L is the WIP, λ is the arrival rate, and W, turn-around time. A timeliness analysis is performed 72 for one or more equivalence classes by plotting the histograms of turn-around times for jobs in each class. This yields the percentage and distribution of late jobs for each job equivalence class. A wasted (labor and machine) time analysis is performed 74 by adding up all the times devoted to non value added activities like set ups, transportation, and rework. The amount of time wasted by virtue of WIP sitting unprocessed on the floor also is determined. A capacity analysis is performed 76 for each equivalence class of jobs, i.e., what is the production rate required to meet customer demand over various specified time periods. Typically the variation between the minimum and peak capacities can be factors of five or ten, so that this analysis is crucial to determine the investment level and business model required for the shop needs to meet its demand in a fashion that both satisfies the customers and is profitable for the shop. A job profile analysis 78 reveals how many jobs are flowing through the shop for each equivalence class that it handles. A volume analysis 80 yields how many individual documents are produced for each equivalence class of jobs. Calculations are made of equipment and labor utilization. Equipment utilization (for any selected time period) is evaluated 82 by comparing the actual production with the possible production at the measured production rates for each piece of equipment at its measured availability. Labor utilization is obtained 84 by comparing the labor hours needed from the equipment utilization analysis and labor requirements for each production step, with the total paid labor hours for the corresponding time period. Waste numbers are analyzed by job class and by process step to identify opportunities to reduce it.

Further analysis depends on the nature of the results for the current state. If the complexity of jobs is low and the utilization rates are low, very simple analyses (e.g., typical black belt projects) can lead to great improvement in the productivity of the shop. If the complexity of jobs is high and the utilization rates are low, analyses of the average parameters of the shop can be used to make major productivity improvements. This is the domain of typical print shops for which automated data collection, data reporting, and data assessment tools are currently being developed. If the job complexity and utilization rates are both high, full-scale statistical modeling is required to predict the effect of proposed improvements in shop performance.

A representative inquiry format for the desired data acquisition may comprise the following format.

### SITE ASSESSMENT DATA ACQUISITION

### General Production Center Information

How many days per week does the Production Center operate?
How many shifts per day?
How many operators per shift?
What is the average monthly volume?
What is the average turn-around time for jobs?
What are the typical types of jobs that are produced in the Production Center (e.g., transaction printing, publishing, print-on-demand, or a mix of these types)?

### Contract Information

What type of contract do you have with the customer—Cost per copy, fixed minimum or another type?
What is the monthly minimum you bill?
What is the impact of reducing labor in the print shop on your P&L—immediate as well as the long-term impact?
How do you bill the customer for work vended out?
What is the turn-around time (TAT) requirement that you are supposed to meet?
Are there any other relevant features of the contract that you would like us to know?
Is consolidation being planned in the future?
How do you bill your customer and where do you collect the billing information?

### Operation Information

Please complete the file to include:
Account Associate name
Identify all hours and days of the week the Account Associate is available to work
What equipment each Account Associate is trained to operate with identified skill level:
VP: Very proficient (many years of experience)
P: Proficient (been working on this for a few months)
B: Beginner (undergoing training to use this equipment)
In addition to equipment, identify software tools (whether or not they are currently used in your Production Center), that each Account Associate is familiar with. Identify the skill level as indicated above.
Identify whether or not each Associate can use the internet browser.

### Software Information

List all the software tools used in the facility to include:
Product name and version
Functionality (e.g., graphics, publishing, etc.)
Cost
All Associates who can use the software (see Operator Information above)

### Production Center Layout/Floor Plan

Provide a floor plan (to scale) of the facility describing how the facility is currently organized, specifically highlighting the:
inventory area, location of each piece of equipment, and personnel office location.
If the floor plan is not-to-scale, please provide accurate measurements to include footprints required for each piece of equipment.
Provide information with respect to any special constraint on power sources needed to operate the equipment.

### Manual Processing Information

List all of the manual processing steps that occur at your site. For each of these steps, include the following:
Name of the process
Functionality (e.g., printing, bindery, etc.)
Number of shifts this process operates
Number of operators required to do this step
Processing rate information (average per person per minute/hour)
List any equipment that is used to assist the manual processing
If set-up time is required, the amount of set-up time associated with this step in the process
Describe any constraint (or strong preference) with respect to location where such manual processing can happen (e.g., packaging is done by the loading dock)
Describe your quality control process
Describe any other information on the equipment that you think is unique to the equipment.

### Equipment Information

List all equipment used at the facility with the specifics of each.
Equipment name and model number
Functionality (i.e. it's primary purpose—printing, bindery, shrink-wrapping, etc.)
Footprint information (i.e. the floor area occupied by the equipment
Power/electrical requirements
Number of shifts the equipment is used and the number of hours per shift it is typically in production
Number of operators required to operate each piece of equipment
Equipment processing (throughput) rate
Equipment failure rate (i.e. how often it fails)
Average time to repair a failed piece of equipment plus the associated cost to fix it
Average time it takes to set up the equipment for a new job and the number of operators it takes to perform the job set-up
Specific paper/material handling constraints that exist (e.g., the equipment is unable to handle specific types of stock)
If the equipment has any built in quality check mechanisms, please describe
Any constraint the equipment might have with respect to location of other equipment or personnel in its vicinity (e.g., special ventilation requirements)
How the finished output of the equipment is transferred to the next step in the work process
Any other information you think is unique to the equipment (off-line, in-line, level of automation, etc.)

### Submission Information

Please walk us through the process flow and answer the following questions:
How does the customer submit his/her job? (e.g., walk-up, electronic, e-mail, media)
What percentage of the jobs are submitted electronically?
When jobs are submitted, do you have a good estimate of the job characteristics (# of original pages, etc.)?

### Job Profile Information

Describe some typical jobs that are processed in the facility. Include the following:
Job name or identifier
Job arrival date and time
Job due date and time
Job size
All the steps in the workflow needed to produce the finished product with specific assembly instructions if any.
Current amount of time required to process the job
How the jobs is currently scheduled for production
How the job is current tracked from job submission to completion

### Material Handling Information

Specify the different material handling equipment used in the facility.
How is the material transported from the inventory area to individual processing stations?
How is material transported in between processing stations?

### Inventory Information

Describe the following for each (category of) inventory item:
How often do you replenish your inventory?
In what quantities do you replenish your inventory?

### Shipping Information

What are the different delivery/shipping options being used for delivery the final products?
Are there specific times during the day when the finished product gets shipped?

After acquisition of the information identified in the foregoing inquiries, the analysis processes of FIG. 4 are preformed in an overall adjustment in the job layout, workflow and labor, and agglomerization can be affected for a more efficient print shop operation.

Another aspect of the subject embodiments concerns insuring high job flow through a shop by identifying bottlenecks via the measurement of flow metrics and to relieve these bottlenecks by the reassignment of labor, the addition of buffers, the reassignment of equipment, and the reprioritizing of jobs (e.g., in order to schedule first jobs that avoid the bottleneck). Similar notions can be applied even to a single printer. This is a workable and valuable aspect in print shops because they handle a wide variety of jobs that entail a wide variety of equivalence classes as described in connection with FIG. 2. This implies that flow can be increased by making relatively minor adjustments in the production steps (e.g., the addition of buffers, or the reorganization of the steps), or the reassignment of labor (especially cross trained labor by assigning them to the bottlenecks), by routing jobs through autonomous cells based on an optimization or bidding scheme, on a longer time scale, by the reorganization of the layout of the shop, e.g., into autonomous cells.

Another way of describing this invention is that the control policies for a shop are designed in conjunction with the characteristics, most particularly the throughput and perceived reliability, of the individual process steps. Then when a machine breaks or a person is sick, etc., the control policy is modified because the characteristics of the process steps have changed. In this point of view, the sensing is the measurement of the characteristics (product rate, operating or down state, error indications (e.g., paper jam, defect generation), set up characteristics, etc.) of each step in the process in real time. These data are inputs into a controller that specifies the actuation used to improve the flow. Typical actuations might be to assign more labor to a bottleneck process step, assign buffers associated with this step, change routings to avoid this step, etc.

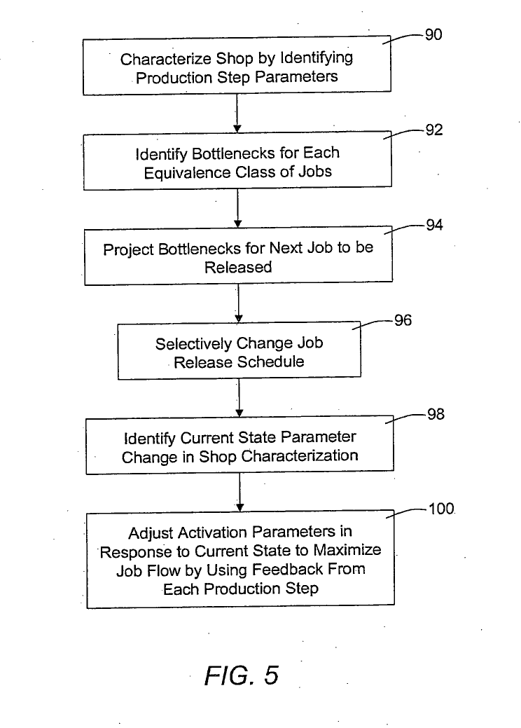

With reference to FIG. 5, the method used to accomplish this in a shop is to proceed in three steps. First, the shop is characterized 90. The parameters characterizing each production step are obtained. Then the job flow through the shop is mapped for some fixed time horizon, typically a few weeks for a small shop ($1-10M annual revenue) and up to a year for a large complex shop (100M+ per year). This step involves calculating the flows along all the arrows in the process diagrams (FIG. 2) for jobs in on the floor of the shop at the selected time. Second, since the flows have been characterized quantitatively bottlenecks are identified 92 for each equivalence class of jobs. These in general depend on the parameters of the jobs (e.g., depending on the number of pages in a book the bottleneck can be either printing or binding) and the availability of labor and equipment. Thus at any one time, the flow of jobs in the shop is completely known, as are the bottlenecks associated with these jobs. Typically, a CONWIP-type control policy (CONstant Work In Progress) is adopted whereby only a few jobs are on the floor of the shop at a given instance. Similarly, the next few jobs expected to be released next have been identified by a separate control policy (sequencing) typically designed to meet customer expectations (e.g., least slack or if this is not relevant, small jobs first). Thus, where the bottlenecks will be for these jobs is projected 94 and if appropriate, the selection of jobs to be released next is accordingly changed 96 to minimize bottleneck obstruction to the job flow.

A print shop floor is a dynamic entity. Machines jam and break. They run out of toner or paper. Supplies of specialty paper run out unexpectedly. Workers take unexpected breaks or call in sick. In short, during the course of a day the conditions on the floor change in unexpected ways. Step three is to use the characterization of the shop and its current and immediately prospective job flows to respond to unexpected changes by adjusting the actuation parameters in the shop to respond to its current state in such a fashion that the job flow is maximized (or nearly so). This is done by using feedback from each production step to change in real time the sequencing, scheduling and/or routing of the prospective jobs, the labor assignments of people to machines, or even the production steps themselves (e.g., by inserting a buffer to mitigate the effects of a down machine).

Workers in print shops (and manufacturing environments more generally) are today intuitively trying to do similar things all the time. Books are written on how to do this well (e.g., Eliyahu M. Goldratt, Theory of Constraints (North River Press, Great Barrington 1990). The subject method differs from current practice in three major respects. First, it is based on a quantitative characterization of the production process steps in the shop and the job flows through this shop using known techniques of quantitative manufacturing systems analysis, (e.g., Wallace J. Hopp and Mark L. Spearman, Factory Physics, Irwin McGraw Hill, Boston, 1996.) Some of these techniques have been specifically tailored to the print shop environment. Second, feedback is measured and used from flow parameters to maximize the flow of jobs through the shop rather than maximizing the utilization of the equipment in the shop, which is the current practice in print shops. Third we are envisioning rapid feedback (minutes to hours, i.e., effectively real time) to measure, record and respond to changes in the shop's state so that the sequencing, scheduling and routing of jobs, as well as labor assignments, may be changed on the fly during a shift rather than having to rely on lengthy delays to effect changes at later shifts, days or weeks. One implication of this is that the flow through any routing is dynamically changed to respond to changing requirements and state of the shop. The new aspect is that it is the measured state of the shop rather than a forecast of the state of the shop that is used to make the flow changes. Thus, the subject embodiment describes an analog for manual print shop environments of the automated computer based method and system described in Duke, Jackson and Rai, “Interactive, Distributed Communication Method and System for Bidding On, Scheduling, Routing and Executing a Document Processing Job”, U.S. Pat. No. 6,573,910 B1. These functions can be automated and embedded in a distributed computer/communications system as described in that patent, but they can be done manually (or semi-automated using computer tools like spreadsheets) as well as described herein.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

1. A system and method for an acquisition and analysis of data for print shop performance evaluation comprising:
characterizing the shop;
characterizing job flow through the shop;
analyzing a current state; and,
assessing possible future states for maximizing the job flow.

2. The system and method of claim 1 wherein the characterizing the shop comprises measuring equipment profiles, operator profiles, business model, materials handling practices including inventory, job input-output methods, production-stop parameters, scheduling policies and billing policies.

3. The system and method of claim 1 wherein the characterizing job flow comprises measuring job parameters including size, production steps, start-stop times for each step, and operator and equipment requirements; dividing jobs into equivalent classes; and, evaluating turn-around time for each class and parameter distributions for each class.

4. The system and method of claim 1 wherein the analyzing a current state comprises evaluating shop metrics including equipment utilization, labor utilization, work in progress, job lateness and equipment throughput.

5. The system and method of claim 1 wherein the analyzing potential future states includes proposing a simulated job flow and comparing results to the current state.

6. A system and method for use of feedback based on flow metrics to control print shop productivity comprising monitoring a state of events in the shop measuring a flow of jobs through the shop and adjusting the routing, batching, agglomerization, job scheduling and labor scheduling to improve the flow and productivity of the shop.

7. A method for acquisition and analyses of data for print shop performance wherein the acquisition comprises determining:
shop layout and equipment characteristics;
possible jobs;
a workflow map;
production step parameters;
labor requirements;
labor force characteristics; and
waste identification.

8. The method as described in claim 7 further comprising analyzing the acquired data for adjusting and improving a print shop operation comprising:
identifying minimal floor space requirements for each production step;
mapping jobs into equivalence classes;
assessing variations in job load as a function of time;
analyzing an amount of work in process at each production step;
calculating turn-around time;
analyzing timeliness for equivalent classes;
analyzing wasted time;
analyzing capacity for equivalent job classes;
analyzing for job profiles;
analyzing job volume;
evaluating equipment utilization; and
evaluating labor utilization.

9. A method for controlling print shop productivity with the use of real time feedback based on flow metrics of a job in current process in the shop, comprising:
quantitatively characterizing a production process work flow through processing elements of the print shop;
measuring operating flow metrics representative of a print shop current state;
identifying a change in a current state indicative of a reduction in flow efficiency;
adjusting a processing sequence of the job to increase the job flow for the job whereby the operating flow metrics are identified for the adjusting in real time for maximizing the flow of jobs through the shop; and
adjusting the allocation of labor to specific job processing steps to improve the flow of jobs through the shop.

10. The method of claim 9 wherein the characterizing comprises obtaining a set of operating parameters representative of a production step in the job.

11. The method of claim 10 wherein the characterizing further comprises mapping a job flow for the job for a preselected fixed time horizon.

12. The method of claim 10 wherein the characterizing comprises assigning an equivalence class to the job.

13. The method of claim 12 further including identifying quantitatively bottlenecks for the assigned equivalence class.

14. The method of claim 13 wherein the adjusting comprises changing a job release schedule to minimize bottleneck obstruction to the job flow.

15. The method of claim 9 wherein the measuring comprises obtaining a current job flow and a prospective job flow.

16. The method of claim 15 wherein the adjusting comprises using the characterizing and the measured current and prospective job flows to change actuation parameters for maximizing the current job flow.
